(19) United States
(12) Patent Application Publication
(10) Pub. No.: US 2008/0069609 A1
(43) Pub. Date: Mar. 20, 2008

(54) Fluoroelastomer fuser members having fluoropolymer filler

(75) Inventors: Carla M. Santos, Cabo Rojo, PR (US); Joy L. Longhenry, Webster, NY (US); Kevin H. Taft, Williamson, NY (US); Karen E. Halliley, Marion, NY (US)

Correspondence Address: Patent Documentation Center;Xerox Corporation, Xerox Square 20th Floor, 100 Clinton Ave. S., Rochester, NY, 14644, US

(73) Assignee: Xerox Corporation

(21) Appl. No.: 11/789,981

(22) Filed: Apr. 26, 2007

Related U.S. Application Data
(63) Continuation-in-part of application No. 11/524,155, filed on Sep. 19, 2006.

(51) Int. Cl. G03G 15/20; B32B 27/00

(52) U.S. Cl. 399/321; 428/421

(57) ABSTRACT

A fuser member comprising a) a substrate, and having thereon; b) an intermediate conformable layer comprising a silicone rubber, and having thereon; and c) an outer layer comprising a fluoroelastomer and a fluoropolymer filler.

### CROSS REFERENCE TO RELATED APPLICATIONS

This application is a continuation-in-part of U.S. patent application Ser. No. 11/524,155, filed Sep. 19, 2006 from which priority is claimed, the disclosure of which is totally incorporated herein by reference.

### BACKGROUND

Herein are disclosed fuser members useful in electrostatographic reproducing apparatuses, including digital, image on image, contact electrostatic printing apparatuses, and the like. The present fuser members can be used as fuser members, pressure members, transfuse or transfix members, and the like. In an embodiment, the fuser members comprise an outer layer comprising a fluoroelastomer. In embodiments, the fluoroelastomer is selected from the group consisting of a) copolymers of two of vinylidene fluoride, hexafluoropropylene, and tetrafluoroethylene; b) terpolymers of vinylidene fluoride, hexafluoropropylene, and tetrafluoroethylene; and c) tetrapolymers of vinylidene fluoride, hexafluoropropylene, tetrafluoroethylene and a cure site monomer. In embodiments, the outer coating further comprises a fluoropolymer filler dispersed or contained therein. In embodiments, the outer layer is positioned on a relatively conformable intermediate layer, and in embodiments, the intermediate layer comprises conformable silicone rubber.

In a typical electrostatographic reproducing apparatus, a light image of an original to be copied is recorded in the form of an electrostatic latent image upon a photosensitive member, and the latent image is subsequently rendered visible by the application of electroscopic thermoplastic resin particles and pigment particles, or toner. The visible toner image is then in a loose powdered form and can be easily disturbed or destroyed. The toner image is usually fixed or fused upon a support, which may be the photosensitive member, or other support sheet such as a copy substrate like paper.

The use of thermal energy for fixing toner images onto a support member is well known. To fuse electroscopic toner material onto a support surface permanently by heat, it is usually necessary to elevate the temperature of the toner material to a point at which the constituents of the toner material coalesce and become tacky. This heating causes the toner to flow to some extent into the fibers or pores of the support member. Thereafter, as the toner material cools, solidification of the toner material causes the toner material to be firmly bonded to the support.

Typically, the thermoplastic resin particles are fused to the substrate by heating to a temperature of between about 90° C. to about 200° C. or higher depending upon the softening range of the particular resin used in the toner. It may be undesirable; however, to increase the temperature of the substrate substantially higher than about 250° C. because of the tendency of the substrate to discolor or convert into fire at such elevated temperatures, particularly when the substrate is paper.

Several approaches to thermal fusing of electroscopic toner images have been described. These methods include providing the application of heat and pressure substantially concurrently by various means, a roll pair maintained in pressure contact, a belt member in pressure contact with a roll, a belt member in pressure contact with a heater, and the like. Heat may be applied by heating one or both of the rolls, plate members, or belt members. The fusing of the toner particles takes place when the proper combinations of heat, pressure and contact time are provided. The balancing of these parameters to bring about the fusing of the toner particles is well known in the art, and can be adjusted to suit particular machines or process conditions.

During operation of a fusing system in which heat is applied to cause thermal fusing of the toner particles onto a support, both the toner image and the support are passed through a nip formed between the roll pair, or plate or belt members. The concurrent transfer of heat and the application of pressure in the nip affect the fusing of the toner image onto the support. It is important in the fusing process that no offset of the toner particles from the support to the fuser member takes place during normal operations. Toner particles offset onto the fuser member may subsequently transfer to other parts of the machine or onto the support in subsequent copying cycles, thus increasing the background or interfering with the material being copied there. The referred to “hot offset” occurs when the temperature of the toner is increased to a point where the toner particles liquefy and a splitting of the molten toner takes place during the fusing operation with a portion remaining on the fuser member. The hot offset temperature or degradation of the hot offset temperature is a measure of the release property of the fuser roll, and accordingly it is desired to provide a fusing surface, which has a low surface energy to provide the necessary release. To ensure and maintain good release properties of the fuser roll, it has become customary to apply release agents to the fuser roll during the fusing operation. Typically, these materials are applied as thin films of, for example, nonfunctional silicone oils or mercapto- or amino-functional silicone oils, to prevent toner offset.

U.S. Pat. No. 6,830,819 discloses a fluoropolymer and fluoroelastomer blend as an outer layer of a fuser member.

U.S. Pat. No. 6,918,664 discloses a phase change ink imaging component useful with a phase change ink, wherein the imaging component has an outer fluoroelastomer layer with a fluoropolymer filler dispersed or contained therein.

U.S. Pat. No. 6,910,765 discloses a phase change ink imaging component useful with a phase change ink, wherein the imaging component has an outer fluoroelastomer layer with a fluoropolymer filler dispersed or contained therein.

U.S. Pat. No. 6,387,465 discloses an imageable seamed belt, wherein the seamed belt has an outer fluoroelastomer layer with a fluoropolymer filler dispersed or contained therein.

U.S. Pat. No. 6,327,454 discloses an imageable seamed belt, wherein the seamed belt has an outer fluoroelastomer layer with a fluoropolymer filler dispersed or contained therein.

Current soft fuser members are preferred for use in color products. These silicone rubber fuser members can comprise a metal roller having an outer conformable silicone rubber coating. The silicone rubber provides for mechanical compliance required for nip formation. A fluoroelastomer topcoat is then coated over the silicone rubber to aid in toner release. Fluoroelastomer outer coatings do not swell when contacted by nonfunctional or functional silicone fluids, and are more durable and abrasion resistant than other coated fuser members, such as silicone rubber coated fuser members. However, in machines working with color toner, the fluoroelastomer layer wears easily and does not release toner as well as fluoropolymers, such as TEFLON®-like fluoropolymers. In addition, fluoropolymers sinter at temperatures greater than the silicone rubber can withstand, and present problems of adhesion to the silicone layer.

Therefore, for fluoroelastomeric fuser member useful in color machines, there exists a specific need for an outer layer with increased wear, improved toner release, and one which diminishes or eliminates problems of adhesion to the silicone layer. In addition, it is desired to provide a fluoroelastomer fuser member coating that allows for lower curing temperatures when used with a conformable silicone rubber intermediate layer.

### SUMMARY

Embodiments include: a fuser member comprising a) a substrate, and having thereon; b) an intermediate conformable layer comprising a silicone rubber, and having thereon; c) an outer layer comprising a fluoroelastomer and a fluoropolymer filler.

Embodiments also include: a fuser member comprising a) a substrate; b) an intermediate conformable layer comprising a silicone rubber having a thickness of from about 0.5 to about 20 mm and having a durometer of from about 53 to about 85 Shore A, and having thereon; an outer layer comprising a fluoroelastomer selected from the group consisting of i) copolymers of two of vinylidene fluoride, hexafluoropropylene and tetrafluoroethylene; ii) terpolymers of vinylidene fluoride, hexafluoropropylene and tetrafluoroethylene; and iii) tetrapolymers of vinylidene fluoride, hexafluoropropylene, tetrafluoroethylene, and a cure site monomer.

Embodiments further include: an image forming apparatus for forming images on a recording medium comprising: a charge-retentive surface to receive an electrostatic latent image thereon; a development component comprising a developer material, said development component to apply a developer material to the charge-retentive surface to develop the electrostatic latent image to form a developed image on the charge retentive surface; a transfer component to transfer the developed image from the charge retentive surface to a copy substrate; a fuser member for fusing the developed image to a copy substrate, wherein said fuser member comprising a) a substrate, and having thereon; b) an intermediate conformable layer comprising a silicone rubber, and having thereon; and c) an outer layer comprising a fluoroelastomer and a fluoropolymer filler.

### BRIEF DESCRIPTION OF THE DRAWINGS

For a better understanding, reference may be had to the accompanying figures.

FIG. 1 is a schematic illustration of a general electrostatographic apparatus.

FIG. 2 is a sectional view of a fuser assembly in accordance with one embodiment herein.

FIG. 3 is an enlarged, sectional view of an embodiment of a fuser member, showing a fuser member with a substrate, intermediate layer, and filled outer layer.

### DETAILED DESCRIPTION OF THE PRESENT INVENTION

The disclosure herein relates to fuser members having a substrate, conformable intermediate layer, and outer fluoropolymer filled fluoroelastomer configuration. The addition of the fluoropolymer additive to the fluoroelastomer outer coating, in embodiments, improves topcoat wear properties, improves toner release, diminishes or eliminates problems of adhesion to the silicone layer, and allows for lower curing temperatures when used with a conformable silicone rubber intermediate layer.

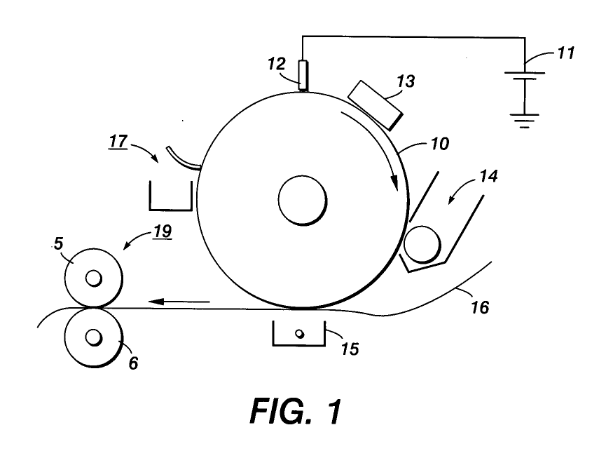

Referring to FIG. 1, in a typical electrostatographic reproducing apparatus, a light image of an original to be copied is recorded in the form of an electrostatic latent image upon a photosensitive member and the latent image is subsequently rendered visible by the application of electroscopic thermoplastic resin particles, which are commonly referred to as toner. Specifically, photoreceptor 10 is charged on its surface by means of a charger 12 to which a voltage has been supplied from power supply 11. The photoreceptor is then imagewise exposed to light from an optical system or an image input apparatus 13, such as a laser and light emitting diode, to form an electrostatic latent image thereon. Generally, the electrostatic latent image is developed by bringing a developer mixture from developer station 14 into contact therewith. Development can be effected by use of a magnetic brush, powder cloud, or other known development process. A dry developer mixture usually comprises carrier granules having toner particles adhering triboelectrically thereto. Toner particles are attracted from the carrier granules to the latent image forming a toner powder image thereon. Alternatively, a liquid developer material may be employed, which includes a liquid carrier having toner particles dispersed therein. The liquid developer material is advanced into contact with the electrostatic latent image and the toner particles are deposited thereon in image configuration.

After the toner particles have been deposited on the photoconductive surface, in image configuration, they are transferred to a copy sheet 16 by transfer means 15, which can be pressure transfer or electrostatic transfer. Alternatively, the developed image can be transferred to an intermediate transfer member and subsequently transferred to a copy sheet.

After the transfer of the developed image is completed, copy sheet 16 advances to fusing station 19, depicted in FIG. 1 as fusing and pressure rolls, wherein the developed image is fused to copy sheet 16 by passing copy sheet 16 between the fusing member 5 and pressure member 6, thereby forming a permanent image. Photoreceptor 10, subsequent to transfer, advances to cleaning station 17, wherein any toner left on photoreceptor 10 is cleaned therefrom by use of a blade (as shown in FIG. 1), brush, or other cleaning apparatus.

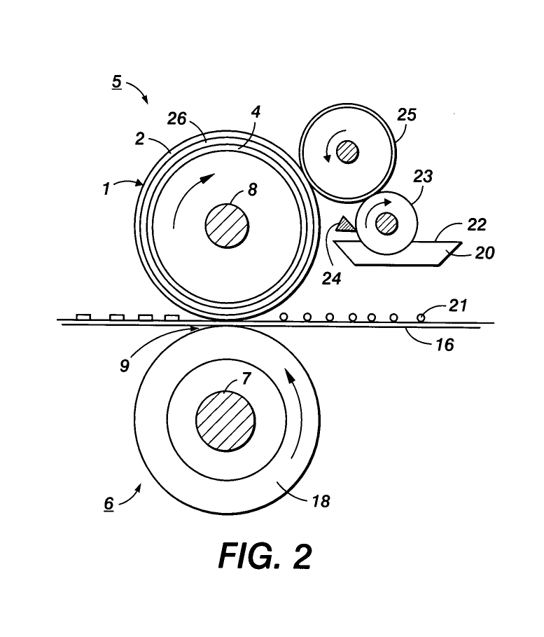

In FIG. 2, fuser roller 5 can be a hollow cylinder or core fabricated from any suitable metal, such as aluminum, anodized aluminum, steel, nickel, copper, and the like, having a suitable heating element 8 disposed in the hollow portion thereof which is coextensive with the cylinder. In embodiments, the core comprises aluminum. In an optional embodiment, the fuser member can be in the form of a belt, drelt (cross between a drum and a belt), film, sheet, or like form.

Backup or pressure roll 6 cooperates with fuser roll 5 to form a nip or contact arc 9 through which a copy paper or other substrate 16 passes such that toner images 21 thereon contact fluoroelastomer surface 2 of fuser roll 5. As shown in FIG. 2, the backup roll 6 has a rigid steel core 7 with a polymer surface or layer 18 thereon. Sump 20 contains polymeric release agent 22 which may be a solid or liquid at room temperature, but it is a fluid at operating temperatures.

In the embodiment shown in FIG. 2 for applying the polymeric release agent 22 to fluoroelastomer surface 2, two release agent delivery rolls 23 and 25 rotatably mounted in the direction indicated are provided to transport release agent 22 to fluorocarbon surface 2. Delivery roll 23 is partly immersed in the sump 20 and transports on its surface release agent from the sump to the delivery roll 23. By using a metering blade 24, a layer of polymeric release fluid can be applied initially to delivery roll 23 and subsequently to fluorocarbon elastomer 2 in controlled thickness ranging from submicrometer thickness to a thickness of several micrometers of release fluid. Thus, by metering device 24, about 0.1 to about 2 micrometers or greater thicknesses of release fluid can be applied to the surface of fluorocarbon elastomer 2. A web metering system that provides 0.05±0.01 microlitres of release fluid may be used. It has been shown that low oil rates aggravate voltage potentials.

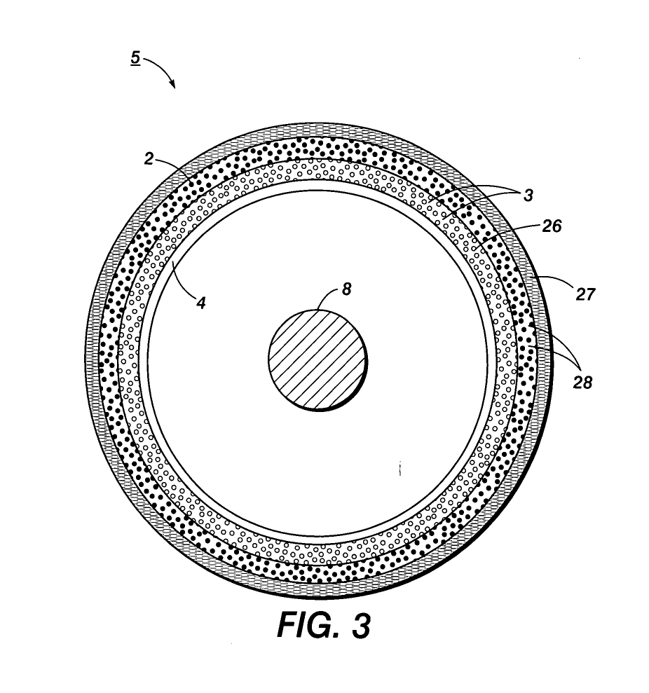

FIG. 3 demonstrates a fuser configuration, wherein fuser roller 5 has heating member 8 inside substrate 4 having intermediate layer 26 (which can be a silicone rubber) positioned on substrate 4, and outer layer 2 positioned on intermediate layer 26. FIG. 3 demonstrates optional fillers 3 and 28, which may be the same or different, and can be dispersed optionally in the intermediate layer 26, and are dispersed in the outer layer 2.

In embodiments, there may be present an outer release layer 27 positioned on the outer layer 2 as shown in FIG. 3. This layer may be of a polymer form, or may be a fuser release oil or fuser oil of liquid form.

Examples of the outer surface of the fuser system members include fluoroelastomers. Specifically, suitable fluoroelastomers are those described in detail in U.S. Pat. Nos. 5,166,031, 5,281,506, 5,366,772 and 5,370,931, together with U.S. Pat. Nos. 4,257,699, 5,017,432 and 5,061,965, the disclosures each of which are incorporated by reference herein in their entirety. As described therein, these elastomers are from the class of 1) copolymers of two of vinylidenefluoride, hexafluoropropylene, and tetrafluoroethylene; 2) terpolymers of vinylidenefluoride, hexafluoropropylene and tetrafluoroethylene; and 3) tetrapolymers of vinylidenefluoride, hexafluoropropylene, tetrafluoroethylene and cure site monomer. These fluoroelastomer are known commercially under various designations such as VITON A®, VITON B®, VITON E®, VITON E 60C®, VITON E430®, VITON 910®, VITON GH®; VITON GF®; VITON ETP®. The VITON® designation is a Trademark of E.I. DuPont de Nemours, Inc. The cure site monomer can be 4-bromoperfluorobutene-1,1,1-dihydro-4-bromoperfluorobutene-1,3-bromoperfluoropropene-1,1,1-dihydro-3-bromoperfluoropropene-1, or any other suitable, known cure site monomer commercially available from DuPont. Other commercially available fluoropolymers include FLUOREL 2170®, FLUOREL 2174®, FLUOREL 2176®, FLUOREL 2177® and FLUOREL LVS 76®, FLUOREL® being a Trademark of 3M Company. Additional commercially available materials include AFLAS™ a poly(propylene-tetrafluoroethylene) and FLUOREL II® (LII900) a poly(propylene-tetrafluoroethylenevinylidenefluoride) both also available from 3M Company, as well as the Tecnoflons identified as FOR-60KIR®, FOR-LHF®, NM® FOR-THF®, FOR-TFS®, TH®, and TN505®, available from Montedison Specialty Chemical Company.

Examples of three known fluoroelastomers are (1) a class of copolymers of two of vinylidenefluoride, hexafluoropropylene and tetrafluoroethylene, such as those known commercially as VITON A® (2) a class of terpolymers of vinylidenefluoride, hexafluoropropylene and tetrafluoroethylene known commercially as VITON B® and (3) a class of tetrapolymers of vinylidenefluoride, hexafluoropropylene, tetrafluoroethylene and cure site monomer known commercially as VITON GH® or VITON GF®.

The fluoroelastomers VITON GH® and VITON GF® have relatively low amounts of vinylidenefluoride. The VITON GF® and Viton GH® have about 35 weight percent of vinylidenefluoride, about 34 weight percent of hexafluoropropylene, and about 29 weight percent of tetrafluoroethylene with about 2 weight percent cure site monomer.

The amount of fluoroelastomer compound in solution in the outer layer solutions, in weight percent of total solids, is from about 10 to about 25 percent, or from about 16 to about 22 percent by weight of total solids. Total solids as used herein include the amount of fluoroelastomer, optional adjuvants and fillers, other solid materials, and includes the fluoropolymer filler.

In addition to the fluoroelastomer, the outer layer may comprise a fluoropolymer or other fluoroelastomer blended with the above fluoroelastomer. Examples of suitable polymer blends include the above fluoroelastomer blended with a fluoropolymer selected from the group consisting of polytetrafluoroethylene and perfluoroalkoxy. The fluoroelastomer can also be blended with non-fluorinated ethylene or non-fluorinated propylene.

The substrate, intermediate layer, and/or outer layer, in embodiments, may comprise fillers dispersed therein. These fillers can have the ability to increase the material hardness or modulus into the desired range.

A filler is included in the outer fluoroelastomer layer. The filler is a fluoropolymer. Examples of suitable fluoropolymer fillers include TEFLON®-like fillers such as polytetrafluoroethylene (PTFE) powder, perfluoroalkoxy (PFA) materials, fluorinated ethylenepropylene copolymer (FEP), polyfluoroalkoxy polytetrafluoroethylene (PFA TEFLON®), ethylene chlorotrifluoro ethylene (ECTFE), ethylene tetrafluoroethylene (ETFE), polytetrafluoroethylene perfluoromethylvinylether copolymer (MFA), and the like, and mixtures thereof. Specific commercially available fluoropolymer fillers include those sold under the names DYNEON® THV 200A; ZONYL® MP 1000; and the like. The fluoropolymer filler is present in the outer fluoroelastomer layer in an amount of from about 10 to about 50 percent, or from about 20 to about 40 percent, or from about 30 to about 35 percent by weight of total solids.

A filler can be included in the intermediate layer, and a second filler can be included along with the fluoropolymer filler, in the outer layer. Examples of suitable fillers for inclusion in the intermediate layer, and for inclusion in the outer layer (in addition to the fluoropolymer filler) include fillers such as metals, metal oxides, doped metal oxides, carbon blacks, ceramics, polymers, and the like, and mixtures thereof. Examples of suitable metal oxide fillers include titanium dioxide, tin (II) oxide, aluminum oxide, indium-tin oxide, magnesium oxide, copper oxide, iron oxide, silica or silicon oxide, and the like, and mixtures thereof. Examples of carbon fillers include carbon black (such as N-990 thermal black, N330 and N110 carbon blacks, and the like), graphite, fluorinated carbon (such as ACCUFLUOR® or CARBOFLUOR®), and the like, and mixtures thereof. Examples of ceramic materials include aluminum nitrate, boron nitride, silicates such as zirconium silicates, and the like, and mixtures thereof. Examples of polymer fillers include polytetrafluoroethylene powder, polypyrrole, polyacrylonitrile (for example, pyrolyzed polyacrylonitrile), polyaniline, polythiophenes, and the like, and mixtures thereof. The optional filler is present in the intermediate layer, and/or outer layer in an amount of from about 0 to about 30 percent, or from about 1 to about 20 percent, or from about 1 to about 5 percent by weight of total solids in the layer.

The thickness of the outer fluoroelastomer surface layer of the fuser member herein is from about 10 to about 250 micrometers, or from about 15 to about 100 micrometers.

The intermediate silicone rubber layer is conformable, in embodiments. The intermediate layer may be present between the substrate and the outer fluoroelastomer surface. Examples of suitable intermediate layers include silicone rubbers such as room temperature vulcanization (RTV) silicone rubbers; high temperature vulcanization (HTV) silicone rubbers and low temperature vulcanization (LTV) silicone rubbers. These rubbers are known and readily available commercially such as SILASTIC® 735 black RTV and SILASTIC® 732 RTV, both from Dow Corning; and 106 RTV Silicone Rubber and 90 RTV Silicone Rubber, both from General Electric. Other suitable silicone materials include the siloxanes (such as polydimethylsiloxanes); fluorosilicones such as Silicone Rubber 552, available from Sampson Coatings, Richmond, Va.; liquid silicone rubbers such as vinyl crosslinked heat curable rubbers or silanol room temperature crosslinked materials; and the like. Another specific example is Dow Corning Sylgard 182. The intermediate layer has a thickness of from about 0.5 to about 20 mm, or from about 1 to about 5 mm. The intermediate layer is conformable and has a durometer of from about 53 to about 85 or from about 64 to about 80 Shore A.

There may be provided an adhesive layer between the substrate and the intermediate layer. There may also be an adhesive layer between the intermediate layer and the outer layer. In the absence of an intermediate layer, the fluoroelastomer layer may be bonded to the substrate via an adhesive layer.

Generally, the fuser member can be produced by priming a metal core (in embodiments, the core may comprise aluminum). The primer is used to promote adhesion of the intermediate layer. A silicone rubber intermediate layer is applied to the top in any known and suitable manner, such as injection or compression molding, or the like. The outer fluoroelastomer layer is then applied to the silicone rubber layer by any suitable means, such as by flowcoating, or the like. The fluoropolymer fillers are directly added to the fluoroelastomer during the mixing process.

Release agents or fusing oils can be provided onto the outer layer of the fuser member via a delivery mechanism such as a delivery roll. The delivery roll is partially immersed in a sump, which houses the fuser oil or release agent. The oil is renewable in that the release oil is housed in a holding sump and provided to the fuser roll when needed, optionally by way of a release agent donor roll in an amount of from about 0.1 to about 20 mg/copy, or from about 1 to about 12 mg/copy. The system by which fuser oil is provided to the fuser roll via a holding sump and optional donor roll is well known. The release oil may be present on the fuser member in a continuous or semicontinuous phase. The fuser oil in the form of a film is in a continuous phase and continuously covers the fuser member.

Examples of suitable fuser oils include amino functional fuser oils, mercapto functional fuser oils, fluorosilicone fuser oils, hydride functional fuser oils, or mixtures thereof.

Alternatively, a blend of functional and nonfunctional fuser oils can be used. For example, in a blend of amino-fluid with fluoro-fluid, the amine groups enable reactivity with the fluoroelastomer substrate while the fluoro-fluid contributes excellent surface wetting characteristics.

A nonfunctional oil, as used herein, refers to oils that do not interact or chemically react with the surface of the fuser member or with fillers on the surface. A functional oil, as used herein, refers to a release agent having functional groups which chemically react with the fillers present on the surface of the fuser member, so as to reduce the surface energy of the fillers so as to provide better release of toner particles from the surface of the fuser member. If the surface energy is not reduced, the toner particles will tend to adhere to the fuser roll surface or to filler particles on the surface of the fuser roll, which will result in copy quality defects.

The disclosed fuser member works specifically well with toners with relatively high pile heights

With the disclosed fuser member, in embodiments, a gardiner gloss of from about 40 to about 100 ggu, or from about 60 to about 80 ggu can be obtained with respect to the fused toner image on the copy substrate. Gloss within these limits is highly desired from a customer standpoint.

All the patents and applications referred to herein are hereby specifically, and totally incorporated herein by reference in their entirety in the instant specification.

The following Examples further define and describe embodiments of the present invention. Unless otherwise indicated, all parts and percentages are by weight.

### EXAMPLES

### Example I

Formation of Fuser Member Coating

A fuser member coating formulation may be prepared from a solvent solution/dispersion containing 100 parts by weight of a hydrofluoroelastomer, DuPont VITON® GF (a tetrapolymer of 35 weight percent vinylidenefluoride, 34 weight percent hexafluoropropylene, 29 weight percent tetrafluoroethylene, and 2 weight percent of a cure site monomer). The VITON® GF may be mixed with 7 parts by weight of DuPont VITON® Curative 50, 1.5 parts by weight magnesium oxide (ELASTOMAG® 170 Special available from Rohm and Hass, Andover Mass.)Mass.), 0.75 parts by weight calcium hydroxide, 0.75 parts by weight carbon black (N990 available from R. T. Vanderbilt Co.), 4.89 parts by weight NOVEC® FC-4430 (available from 3M) and 0.86 parts by weight AKF-290 (available by Wacker) in a mixture of methylethylketone and methylisobutyl ketone. This coating formulation may be dispensed onto a fuser roll surface via flow coating to a nominal thickness of about 20 micrometers. The coating may be cured by stepwise heating in air at 95° C. for about 2 hours, 175° C. for about 2 hours, 205° C. for about 2 hours, and 230° C. for about 24 hours.

### Example II

Formation of Fuser Member Coating Comprising Fluoroelastomer Outerlayer

Fuser roll topcoat formulations may be prepared identically to Example I with the exception of the application of a thin fluoropolymer outerlayer. An adhesive layer may need to be applied, possibly via brush coating, prior to application of this fluoropolymer outerlayer. This adhesive layer may be applied by metering the adhesive via a micro-pump as the fuser roll is rotated at a specific RPM. The fluoropolymer is flowcoated onto the fuser roll via flowcoating procedure documented in previous patents. This component is then cured either by Infrared (IR) curing or by convection oven via process in Example I followed by IR curing. The IR oven heat intensities should be set from about 50 to about 250° C. The heat intensity corresponds to about 2 times the voltage applied to the infrared lamps. The radiant energy curing time is generally selected to be about 5 to about 60 minutes.

While the invention has been described in detail with reference to specific and preferred embodiments, it will be appreciated that various modifications and variations will be apparent to the artisan. All such modifications and embodiments as may readily occur to one skilled in the art are intended to be within the scope of the appended claims.

What is claimed is:

1. A fuser member comprising a) a substrate, and having thereon; b) an intermediate conformable layer comprising a silicone rubber, and having thereon; and c) an outer layer comprising a fluoroelastomer and a fluoropolymer filler.

2. A fuser member in accordance with claim 1, wherein said fluoroelastomer is selected from the group consisting of a) copolymers of two of vinylidene fluoride, hexafluoropropylene and tetrafluoroethylene; b) terpolymers of vinylidene fluoride, hexafluoropropylene and tetrafluoroethylene; and c) tetrapolymers of vinylidene fluoride, hexafluoropropylene, tetrafluoroethylene, and a cure site monomer.

3. A fuser member in accordance with claim 2, wherein the fluoroelastomer is a tetrapolymer of vinylidene fluoride, hexafluoropropylene, tetrafluoroethylene, and a cure site monomer.

4. A fuser member in accordance with claim 3, wherein the fluoroelastomer comprises about 35 weight percent of vinylidenefluoride, about 34 weight percent of hexafluoropropylene, about 29 weight percent of tetrafluoroethylene, and about 2 weight percent cure site monomer.

5. A fuser member in accordance with claim 1, wherein said fluoropolymer filler is selected from the group consisting of polytetrafluoroethylene powder, perfluoroalkoxy materials, fluorinated ethylenepropylene copolymer, polyfluoroalkoxy polytetrafluoroethylene, ethylene chlorotrifluoro ethylene, ethylene tetrafluoroethylene, polytetrafluoroethylene perfluoromethylvinylether copolymer, and mixtures thereof.

6. A fuser member in accordance with claim 5, wherein said fluoropolymer filler is polytetrafluoroethylene powder.

7. A fuser member in accordance with claim 1, wherein said fluoropolymer filler is present in said outer layer in an amount of from about 10 to about 50 percent by weight of total solids.

8. A fuser member in accordance with claim 7, wherein said fluoropolymer filler is present in said outer layer in an amount of from about 20 to about 40 percent by weight of total solids.

9. A fuser member in accordance with claim 1, wherein said substrate is in the form of a roller.

10. A fuser member in accordance with claim 9, wherein said substrate comprises aluminum.

11. A fuser member in accordance with claim 1, wherein said conformable intermediate layer has a thickness of from about 0.5 to about 20 mm.

12. A fuser member in accordance with claim 11, wherein said conformable intermediate layer has a thickness of from about 1 to about 5 mm.

13. A fuser member in accordance with claim 1, wherein said conformable intermediate layer has a durometer of from about 53 to about 85 Shore A.

14. A fuser member in accordance with claim 13, wherein said conformable intermediate layer has a durometer of from about 64 to about 80 Shore A.

15. A fuser member in accordance with claim 1, wherein said outer layer has a thickness of from about 10 to about 250 micrometers.

16. A fuser member in accordance with claim 15, wherein said outer layer has a thickness of from about 15 to about 100 micrometers.

17. A fuser member comprising a) a substrate; b) an intermediate conformable layer comprising a silicone rubber having a thickness of from about 0.5 to about 20 mm and a durometer of from about 53 to about 85 Shore A, and having thereon; an outer layer comprising a fluoroelastomer selected from the group consisting of i) copolymers of two of vinylidene fluoride, hexafluoropropylene and tetrafluoroethylene; ii) terpolymers of vinylidene fluoride, hexafluoropropylene and tetrafluoroethylene; and iii) tetrapolymers of vinylidene fluoride, hexafluoropropylene, tetrafluoroethylene, and a cure site monomer.

18. An image forming apparatus for forming images on a recording medium comprising: a charge-retentive surface to receive an electrostatic latent image thereon; a development component comprising a developer material, said development component to apply a developer material to the charge-retentive surface to develop the electrostatic latent image to form a developed image on the charge retentive surface; a transfer component to transfer the developed image from the charge retentive surface to a copy substrate; a fuser member for fusing the developed image to a copy substrate, wherein said fuser member comprising a) a substrate, and having thereon; b) an intermediate conformable layer comprising a silicone rubber, and having thereon; and c) an outer layer comprising a fluoroelastomer and a fluoropolymer filler.

19. An image forming apparatus in accordance with claim 18, wherein said developer material comprises color toner.

20. An image forming apparatus in accordance with claim 18, wherein said fused image on said copy substrate has a gardiner gloss of from about 40 to about 100 ggu.

21. An image forming apparatus in accordance with claim 19, wherein said fused image on said copy substrate has a gardiner gloss of from about 60 to about 80 ggu.
